(19) United States
(12) Patent Application Publication
(10) Pub. No.: US 2004/0251637 A1
(43) Pub. Date: Dec. 16, 2004

(54) Plug and seal combination for a fluid coupling in automatic transmissions

(75) Inventor: Kyle Gregoire, Windsor (CA)

Correspondence Address: RANDALL J. KNUTH P.C., 3510-A STELLHORN ROAD, FORT WAYNE, IN, 46815-4631, US

(73) Assignee: Polymer Sealing Solutions, Inc.

(21) Appl. No.: 10/766,643

(22) Filed: Jan. 27, 2004

Related U.S. Application Data
(60) Provisional application No. 60/447,435, filed on Feb. 14, 2003.

(51) Int. Cl. F02F 11/00

(52) U.S. Cl. 277/591; 138/89

(57) ABSTRACT

A plug and seal assembly for use in an automatic transmission provides a fluid coupling interface between transmission components to facilitate the passage of fluid. One plug design has a cylindrical body with a terminal edge at one axial end. A seal is joined to the plug at the terminal axial edge and extends both radially inward and radially outward relative to the terminal axial edge. This single seal design provides leak protection between the plug and transmission housing and between the plug and a tube inserted through the plug. Another plug design has a radially extending flange at one end of the cylindrical plug body. An outer seal annularly disposed about the radial flange prevents leakage between the plug and the surrounding transmission parts. An inner annular seal is disposed within the cylindrical body of the plug and prevents leakage between the plug interior and a fluid conveyance tube inserted through the plug. A pierceable sealing membrane spans one of the plug orifices as a sheath-type shroud or cover.

### CONTINUING DATA

This application hereby claims the benefit under Title 35, United States Codes § 119(e) of any U.S. application Ser. No. 60/447,435 filed Feb. 14, 2003, and is hereby incorporated by reference.

### BACKGROUND OF THE INVENTION

1. Field of the Invention

The present invention relates to a fluid coupling device at the interface between components of an automatic transmission, and, more particularly, to a seal assembly for use in a plug configured at such interface.

2. Description of the Related Art

Maintaining the integrity and reliability of the fluid transport mechanism in machine environments is particularly important because the fluid often times is vital to the functioning of critical parts. For example, in automatic transmissions, transmission oil must be suitably cooled in order to remain effective. Otherwise, overheating may occur in the automatic transmission gear apparatus, in addition to an impaired lubrication activity. Additionally, the automatic control also may be adversely impacted from oil deterioration since the automatic control task is facilitated by the flow of transmission oil.

One particularly vulnerable area of the fluid transport system lies at the coupling interfaces between components. If the interface is not suitably sealed, excessive and detrimental fluid loss and leakage may result.

### SUMMARY OF THE INVENTION

According to the present invention, a plug and seal assembly for use in an automatic transmission provides a fluid coupling interface between transmission components to facilitate the passage of fluid.

One plug design has a cylindrical body with a terminal edge at one axial end. A seal is joined to the plug at the terminal axial edge and extends both radially inward and radially outward relative to the terminal axial edge. This single seal design provides leak protection between the plug and transmission housing and between the plug and a tube inserted through the plug. In particular, the inward radial seal portion provides a seal between the plug interior and tube, while the outward radial seal portion provides a seal between the plug exterior and the opposing transmission housing.

The single seal design may be augmented with a sleeve that fits concentrically about and is joined to the plug exterior to thereby offer additional surface area for creating a tighter interference-type press fit engagement with the transmission housing. The sleeve may be formed as an integral extension of the single annular seal.

Another plug design has a radially extending flange at one end of the cylindrical plug body. An outer seal annularly disposed about the radial flange prevents leakage between the plug and the surrounding transmission parts. An inner annular seal in the form of an O-ring is disposed within the cylindrical body of the plug and prevents leakage between the plug interior and a fluid conveyance tube inserted through the plug.

A pierceable sealing membrane spans one of the plug orifices as a sheath-type shroud or cover.

There may be various different forms of the seal assembly having the combination of discrete outer face seal and inner tube seal. In one variation, for example, the inner tube seal may connect with the sealing membrane, thereby forming a single piece. Additionally, the outer face seal may be mechanically bonded to the plug seal. Furthermore, the functionality of the inner tube seal may be implemented with a seal annularly disposed about and joined to the tube.

The plug and seal elements, in all of the assemblies discussed herein, can be constructed as single-piece uni-body structures, such as elastomer.

Generally, in regard to the plug and seal combination having the inner tube seal and outer face seal, the outer face seal joined to the plug is annularly disposed about the plug at its outermost diameter. In one form, where the plug has an annular radially-extending flange, the outer seal is annularly disposed about the radially outermost surface of the flange. This placement of the outer seal is beneficial because it presents a sealing surface to the immediately opposing face of the transmission housing.

In another form, where the plug simply includes a cylindrical body without any flange projections, the outer seal is annularly disposed about the outermost annular surface of the plug, namely, the surface at its outermost diameter.

In another form of the invention, a single assembly or combination is formed of a transmission oil plug, transmission A/C housing block face seal, and an o-ring for the housing block tube(s). In this style, the component count is reduced and eliminates the need for the A/C housing block manufacturer or supplier to assemble components to their block, while additionally reducing the overall amount of elastomer utilized within the system.

One advantage of the present invention is that the seal assembly addresses and accounts for potential fluid leakage both externally and internally of the plug by incorporating an outer seal to provide a sealing action between the plug and the surrounding transmission component(s), and an inner seal to provide a sealing action between the plug interior and the outer surface of the inserted tube.

Another advantage of the present invention is that one form of the seal assembly combines the functionality of the external seal (prevent leakage at the transmission housing-to-plug interface) and the internal seal (prevent leakage at the tube-to-plug interface) into a dual-functionality single-seal structure.

Another advantage of the invention is that the entire seal assembly and plug element can be manufactured as a single-piece uni-body construction, such as an elastomeric structure.

Another advantage of the invention is that the integrity of the plug interior can be preserved from damage and contamination, for example, by the use of a pierceable membrane that spans one of the fluid orifices of the plug element.

Another advantage of the invention is that one form of the seal assembly has an outer seal annularly disposed about the outermost outer diameter of the plug (e.g., the outer periphery of the radially extending plug flange), which allows for self-retention of the seal vis-à-vis the plug since the seal simply form fits about the plug in a passive squeeze-type or clamp-type relationship, enabling ready installation and replacement, if necessary.

Another advantage of the invention is that the once the sealing membrane that covers the plug orifice is pierced upon assembly, the peripheral or circumferential edge of the pierced membrane remains attached to the plug body and serves as an axial end seal to furnish additional leak protection, namely, to seal the plug itself against the transmission housing and thereby prevent leakage around the outside of the plug.

Another advantage of the invention is that by incorporating the seal elements into one assembly, this allows for an overall reduction in the number of components, eliminates the need for the housing block supplier to assemble any components to the block, and reduces the overall amount of elastomer used versus the current parts in production.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a cross-sectional diagrammatic view of a fluid coupling arrangement, to illustrative the conventional problems addressed and solved by the invention;

FIG. 2 is a cross-sectional diagrammatic view of a plug and seal combination, according to one form of the invention;

FIGS. 3A and 3B are cross-sectional diagrammatic views respectively depicting one exemplary plug and seal geometry and field assembly configuration based on the plug and seal combination of FIG. 2, according to one illustrative application of the invention;

FIG. 4 is a cross-sectional diagrammatic view of a plug and seal combination, according to another form of the invention;

FIG. 5 is a cross-sectional diagrammatic view of a plug and seal combination, according to another form of the invention;

FIG. 6 is a cross-sectional diagrammatic view of a plug and seal combination, according to another form of the invention;

FIG. 7 is a cross-sectional diagrammatic view of a plug and seal combination, according to another form of the invention;

FIG. 8 is a cross-sectional diagrammatic view of a plug and seal combination, according to another form of the invention;

FIG. 9 is a cross-sectional diagrammatic view of a plug and seal combination, according to another form of the invention; and

FIG. 10 is a cross-sectional diagrammatic view of a plug and seal combination, according to another form of the invention.

Corresponding reference characters indicate corresponding parts throughout the several views. The exemplification set out herein illustrates one preferred embodiment of the invention, in one form, and such exemplification is not to be construed as limiting the scope of the invention in any manner.

### DETAILED DESCRIPTION OF THE INVENTION

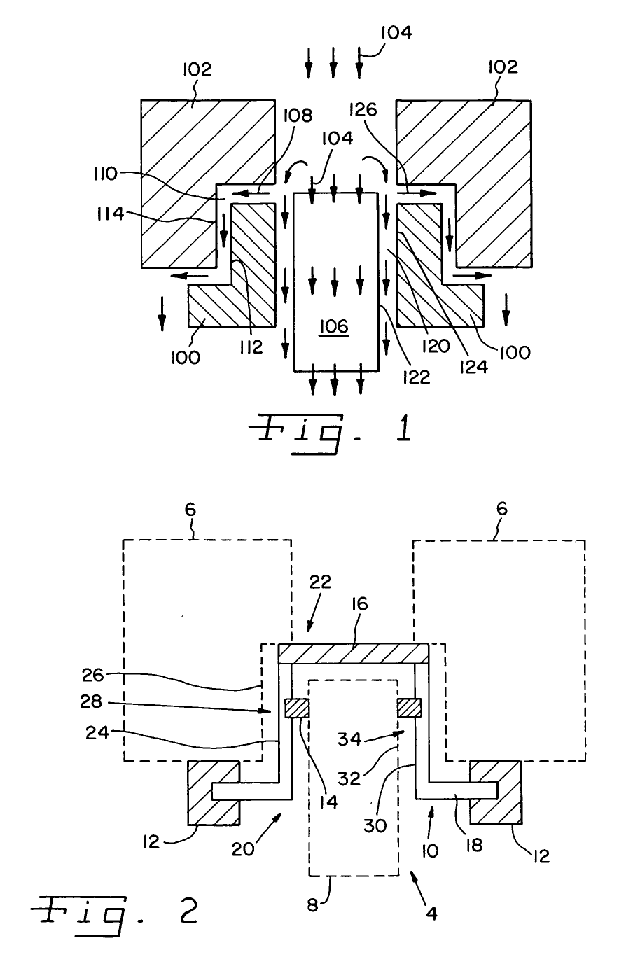

By way of background, reference is first made to FIG. 1 to illustrate the problems that are addressed, solved and overcome by the present invention.

As illustrated in FIG. 1, there is shown a plug 100 disposed in an installed relationship vis-à-vis machine structure 102 (e.g., transmission component) to facilitate the conveyance of fluid 104 from the interior of component 102 into tube 106. The indicated spatial separations between (i) the outer face of plug 100 and the opposing face of component 102, and (ii) the inner diameter face of plug 100 and the opposing annular face of tube 106 are shown in exaggerated view to illustrate the possible migration paths of fluid that lead to detrimental oil leakage.

Fluid that travels towards tube 106 at the outlet point of component 102 may communicate into the interstitial clearance 110 defined between the outer face 112 of plug 100 and the opposing face 114 of component 102, as indicated by illustrative fluid flow 108. Once allowed into clearance 110, fluid flow 108 will typically eventually traverse the full extent of clearance 110 until it leaks externally of plug 100 and component 102 into the ambient environment, as shown.

Additionally, fluid that travels towards tube 106 may communicate into the interstitial clearance 120 defined between the inner diameter surface 124 of plug 100 and the outer annular surface 122 of tube 106, as indicated by illustrative fluid flow 126. Once allowed into clearance 120, fluid flow 126 will typically eventually traverse the full axial extent of clearance 120 until it leaks externally of plug 100 and tube 106 into the ambient environment, as shown.

It is desirable to eliminate both of these sources of leakage from the transmission environment, namely, at the interface involving the plug, fluid transport tube, and transmission housing. Many disadvantages arise from such leakage. For example, the oil may leak onto other parts and compromise their integrity and functionality, such as vehicle sensors, wiring, and belts.

Moreover, since a suitable supply of transmission oil is vital to the proper functioning of automatic transmissions, both for transmission control and cooling/lubrication, any persistent loss in fluid without ready replenishment may lead to transmission malfunctions (e.g., diminished control) or failure, if the loss is significant enough. The same leakage problems would arise if the normal fluid communication was the reverse of that depicted in FIG. 1, namely, from tube 106 to component 102.

As discussed below, the various forms of the invention provide various sealing arrangements to eliminate the leakage paths illustratively depicted in FIG. 1. Generally, it is now possible with the invention to eliminate the occurrence of leakage between the plug and surrounding transmission component(s) and between the plug and fluid transport tube. Accordingly, with the invention, the clearance interface between the plug and transmission parts is sealed, and the clearance interface between the plug and tube is sealed.

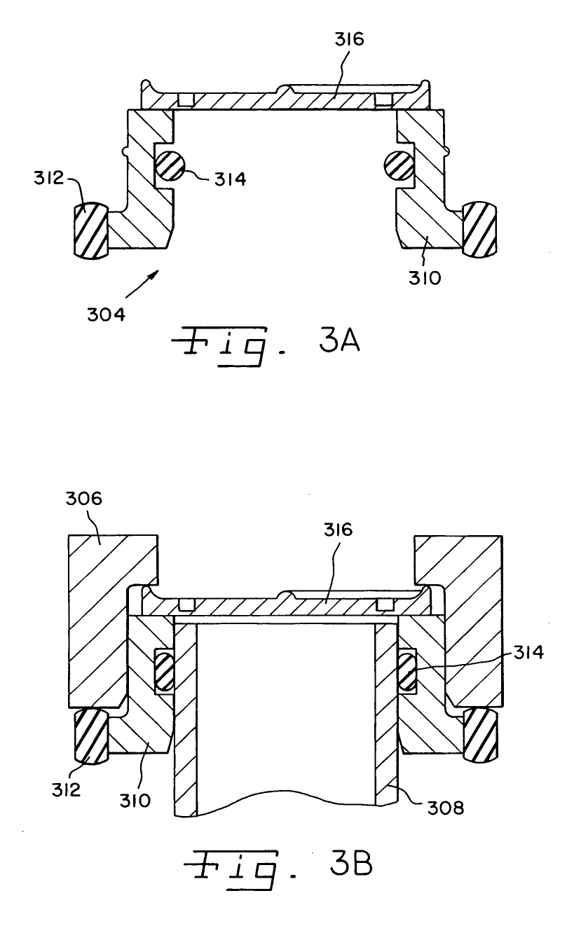

By way of overview, in reference now to the invention, the views shown in FIGS. 2-6 relate to various plug and seal combinations in which the transmission housing block face seal (i.e., external plug-to-housing face seal) and the housing block tube seal (i.e., internal plug-to-tube seal) are provided as discrete seal elements, according to one form of the invention. By comparison, the views shown in FIGS. 7-9 relate to various plug and seal combinations in which the functionality of the transmission housing block face seal and the housing block tube seal are embodied within a single seal structure, according to another form of the invention.

Referring now to FIG. 2, there is shown a plug and seal assembly 4 that includes, in combination, a plug 10, an outer seal 12, an inner seal 14, and a membrane cover seal 16, according to one form of the invention.

Also shown in phantom view are a component 6 and tube 8 to generally illustrate the placement of plug and seal assembly 4 in an assembled installation configuration. For example, component 6 may be a transmission housing block and tube 8 may be a housing block tube. In particular, component 6 can be an automatic transmission oil cooler block that works in conjunction with tube 8 to circulate transmission oil to a cooling unit (e.g., air conditioner or radiator) to cool the transmission oil. These are conventional parts well known to those skilled in the art.

In conventional fashion, for example, oil would be transferred from component 6 through tube 8, which is received within plug 10 that serves as a transmission plug to facilitate fluid coupling in a known manner. A reverse oil flow would also be possible depending upon the use and functionality of component 6, without affecting the benefits and advantages achievable by the invention.

As installed, for example, the plug and seal assembly 4 could be maintained in secure relationship to component 6 by any means known to those skilled in the art. For example, assembly 4 could be captured or held in place by the containment force resulting from a clamping or mounting relationship between component 6 and another adjacent machine part, such as a transmission housing extension that includes tube 8. Additionally, or alternately, the plug may be retained within the transmission by way of an interference fit between the plug and the transmission housing.

Alternately, plug 10 could itself be provided with some means to anchor it to component 6. For example, displaceable ribs or axial splines that slidably register in corresponding channels in component 6 may be optionally attached to the outer surface of plug 10 to facilitate retention of the plug once it is installed (not shown).

The illustrated plug 10 has a body with a generally cylindrical shape having a channel or bore formed therethrough to operably receive tube 8. As used herein, plug 10 preferably has a conventional form well known to those skilled in the art. In the form depicted by FIG. 2, plug 10 further includes an annular radially-extending flange 18, of conventional form. For reference purposes, plug 10 has a proximal end 20 and a distal end 22.

In preferred forms, plug 10 has a conventional design well known to those skilled in the art. For example, plug 10 may form a cup-type structure. Accordingly, it is seen as one advantage that the improvements afforded by the invention can be realized by adapting conventional plug designs to incorporate the seal structures variously described herein. This benefit enables ready practice of the invention since little or no modification need be made to the plug structure. The plug can be made of various known materials, such as plastic or metal. As discussed further, the plug and seal assembly can be formed of the same material, e.g., an elastomer.

The illustrated seal 12 is provided in the form of a ring-type seal annularly disposed about plug 10 and joined to flange 18. In a preferred form, seal 12 fully circumscribes the outermost diameter of plug 10, namely, the radially outermost portion of flange 18. Additionally, seal 12 also extends along the respective radial surfaces on both axial sides of flange 18, as shown. As a result, seal 12 provides a sealing surface that acts against any component that confronts plug 10 on both axial sides of flange 18 and in the radial direction, i.e., at the radially outermost surface of seal 12. Accordingly, although component 6 is shown as confronting plug flange 18 at one axial side thereof, it should be apparent that seal 12 can also act to form a seal with respect to components located at the other opposing axial side of flange 18 and components having a radial confrontation with flange 18.

In general, outer seal 12 serves the purpose of forming a seal between the plug exterior and the confronting surface of the immediately opposing transmission component. For example, outer seal 12 provides a sealing action between the outer surface 24 of plug 10 and the immediately opposing surface 26 of component 6 (during installation). Thus, any fluid present in the illustrative clearance space 28 defined between plug 10 and component 6 will be prevented by seal 12 from escaping past the terminal end of clearance 28 at plug flange 18. In one form, then, outer seal 12 can be considered a face seal.

Referring still to FIG. 2, the illustrated seal 14 is provided in the form of an O-ring type sealing structure disposed within the interior axial channel formed through plug 10. In particular, inner seal 14 is joined to the inner annular surface 30 of plug 10. The manner of joining seal 14 to plug 10 can be accomplished by any of various conventional means known to those skilled in the art, such as bonding or seating of the seal within an annular groove or recess formed in surface 30, as shown.

In general, inner seal 14 serves the purpose of forming a seal between the plug interior and the confronting surface of tube 8 inserted therethrough (i.e., during pre-assembly, assembly, and/or installation). For example, inner seal 14 provides a sealing action between the inner diameter surface 30 of plug 10 and the immediately opposing outer diameter (i.e., circumferential) surface 32 of tube 8. Thus, any fluid present in the illustrative clearance space 34 defined between plug 10 (at surface 30) and tube 8 (at surface 32) will be prevented by seal 14 from escaping past and leaking from plug 10 at its proximal end 20.

Any of various means known to those skilled in the art can be used to configure, attach, join, secure, or otherwise retain the inner O-ring seal within the plug. For example, the O-ring seal may be seated in an annular groove or recess formed in the radially innermost annular surface of the plug. However, if it is desired to leave the plug surface structurally undisturbed or intact, the O-ring seal can simply be attached to the plug surface by way of gluing, bonding or other suitable joining process.

The illustrated membrane 16 is provided in the form of a suitably thin, break-away element that serves to extend over and otherwise span the axial plug orifice defined at the distal end of plug 10. Preferably, pierceable membrane 16 is a continuous structure that fully covers the distal end orifice of plug 10. Membrane 16 is joined to plug 10 at the annular peripheral or circumferential edge defined at the terminal axial end of plug 10. It is therefore seen that membrane 16 extends axially from plug 10 at its terminal axial surface. If desired, membrane 16 may also extend around onto the radially outer surface 24 of plug 10.

In one form, the membrane can be considered to serve as a protective sheath that fully covers the axial orifice at the distal end of the plug body. The membrane, in one form, has a suitably thin, break-away construction that is durable enough during pre-installation to provide packaging protection of the plug, yet is readily yieldable during installation so as to tear open when punctured by the block housing tube during assembly.

Membrane 16 serves to cover the distal plug orifice so as to seal the transmission oil passage upon initial installation of plug 10 into the field environment, namely, coupling to component 6. Membrane 16 will tear away when punctured by the block housing tube 8 during full installation (not shown). However, at least the outermost portion of membrane 16 (i.e., the portion joined to plug 10) will remain intact and continue to be joined to plug 10 in the same manner as before puncture. For example, following puncture, at least an annular ring-type membrane seal will continue to extend axially from plug 10 at its distal end 22. In one form, it may be considered that a membrane edge seal remains after puncture. As shown, the membrane edges also seal plug 10 itself against component 6 (e.g., transmission housing) to prevent leakage around the outside of plug 10. Nevertheless, even if fluid escapes past the punctured membrane seal into clearance 28, outer annular seal 12 will prevent any further oil migration.

The seal structures shown in the figures herein are depicted in a relaxed, non-compressive state. Accordingly, even though FIG. 2, for example, illustrates an installation environment for plug and seal combination 4 as depicted in phantom by component 6 and tube 8, it should be understood that in actual practice, the seals will undergo compression (in known manner) due to the interference-type, press-fit connection between plug and seal assembly 4 and the surrounding environment, e.g., component 6 and tube 8. For example, in FIG. 2, there will be a press fit engagement between inner seal 14 and tube 8 and between outer seal 12 and transmission housing 6, during full installation. This press fit engagement will compress seals 12 and 14 in a known manner, such that both seals will exert a sealing pressure or influence against the opposing surfaces in contact therewith.

Under compression, the seal responsively and/or reactively exerts an outward force directed against the surrounding structures (e.g., transmission components) that are inducing the compression activity. This force is sufficient to develop an adequate sealing pressure between the seal and the components that are being engaged and/or contacted by the seal.

Accordingly, the seals discussed herein will be dimensioned, sized, configured, constructed, or otherwise designed to ensure that the seal will develop a sufficient sealing force once it is installed in the fully assembled field application, e.g., vehicle transmission. This manner of constructing the seal will employ conventional techniques well known to those skilled in the art.

Additionally, the seals discussed herein may be constructed with any of various materials known to those skilled in the art. For example, in preferred forms, the seal will be formed of an elastomeric material. The seal may be provided with varying degrees of elasticity, as can be accomplished using conventional techniques well-known to those skilled in the art. Additionally, any conventional methods may be used to fabricate the seals.

In various forms, the seals discussed herein can be considered to possess and/or exhibit properties enabling or facilitating compression, deformation, distention, and/or flexure.

The manufacture of the pierceable membrane will preferably employ design and construction criteria and considerations similar to those used in the formation of the seals.

Referring now to FIGS. 3A and 3B, there is shown an exemplary plug and seal assembly 304 prior to installation and after fully assembled installation, respectively. Assembly 304 includes, in combination, plug 310, outer face seal 312, inner tube seal 314, and membrane 316 similar to elements 10, 12,14 and 16 in FIG. 2, respectively. In FIG. 3B, the installation environment includes transmission housing block 306 and tube 308 similar to elements 6 and 8 in FIG. 2, respectively.

FIG. 3A shows one possible retention feature. In particular, small elastic bumps or protrusions (single or plural) may be formed on the outer diameter surface of plug 310 that deform under installation forces to secure the plug to the housing.

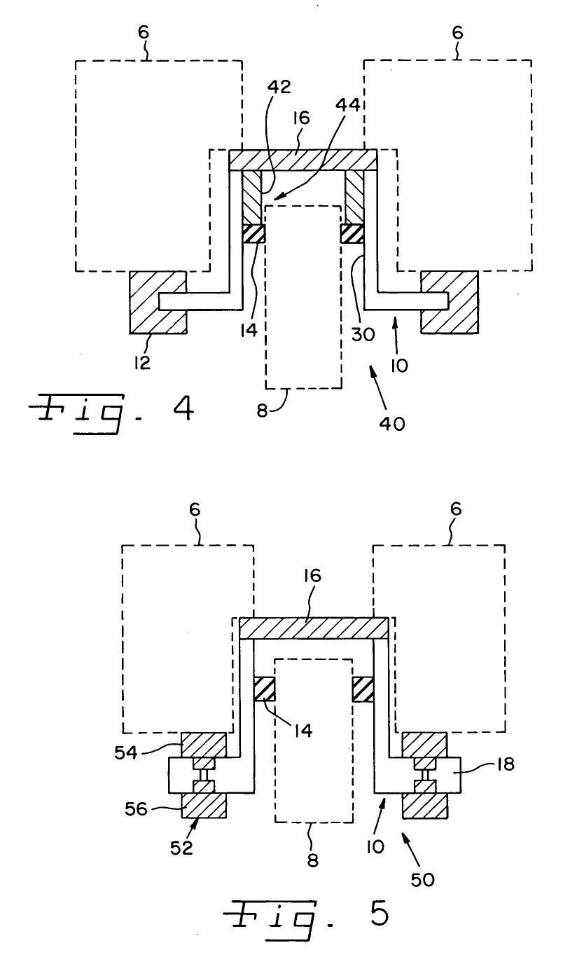

Referring now to FIG. 4, there is shown a plug and seal combination 40 similar to that shown in FIG. 2, but modified to include a means 42 for connecting and extending between inner O-ring seal 14 and membrane 16. In a preferred form, following puncture of membrane 16, connection means 42 will remain joined to membrane 16.

In one form, connection means 42 is provided in the form of an annular seal-type structure joined to the inner annular surface 30 of plug 10. Preferably, the combination of connection means 42, O-ring seal 14, and membrane 16 is integrally provided as a single-piece, uni-body, unitized construction. However, connection means 42 can also be any discrete structure (such as another seal) that can be joined to seal 14 and membrane 16 using any conventional process. Alternately, O-ring seal 14 and connection means 42 together can effectively constitute a uni-body, single-piece inner O-ring seal 44 joined to membrane 16.

One feature of the plug and seal assembly 40 is that connection means 42 effectively closes out any possible clearance between tube 8 and the inner diameter surface of plug 10 along the axial (i.e., longitudinal) dimension spanned by means 42 and O-ring seal 14. For this purpose, it is seen that tube 8 will preferably form a press fit engagement with both element 42 and O-ring seal 14.

In one form, connection means 42 can simply be considered a part of O-ring seal 14 so as to form an effective (but perhaps larger) O-ring seal 44. Accordingly, the form of the invention shown in FIG. 4 should be understood as encompassing an inner annular O-ring seal joined to plug 10 at its inner diameter surface 30 (for sealing at the plug-tube interface), and further joined to (e.g., integrated with) membrane 16.

In another form, the integral formation of the inner O-ring seal and membrane can simply be accomplished by retaining the same size of the O-ring but locating it axially further towards the distal end of the plug immediate the membrane. A single-piece uni-body structure for such O-ring and membrane could then be used. Accordingly, FIG. 4 should be construed as encompassing the integration of the inner tube seal (regardless of specific axial placement or size) with the cover membrane.

The plug and seal assembly 40 operates similarly to the plug and seal assembly 4 of FIG. 2.

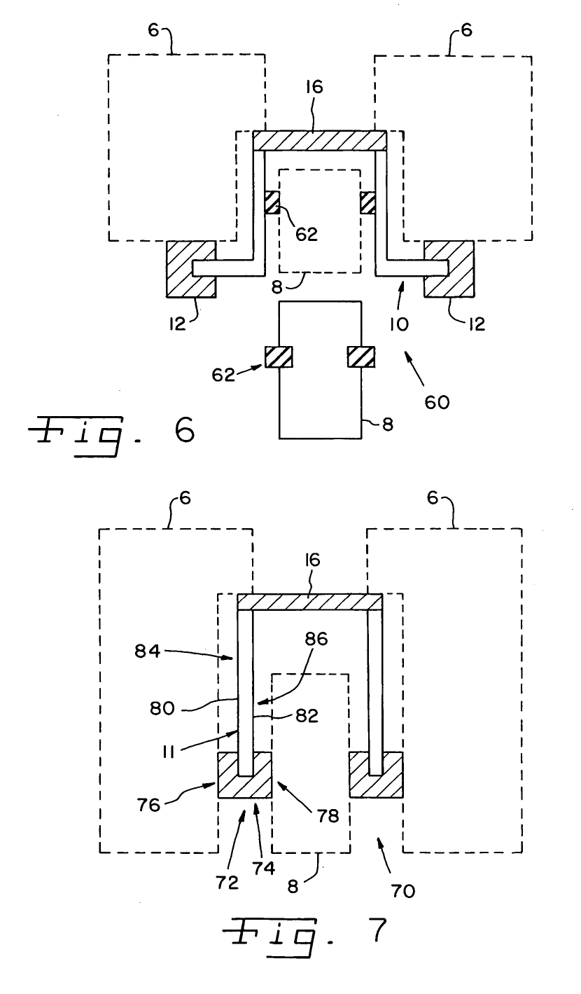

Referring now to FIG. 5, there is shown a plug and seal combination 50 similar to that shown in FIG. 2, but modified to include an outer seal 52 that is mechanically joined (e.g., bonded) to plug 10, namely, at radial flange 18.

In one form, seal 52 is provided in a form having a first ring-type portion 54 annularly disposed about plug 10 and a second ring-type portion 56 annularly disposed about plug 10. As shown, first seal portion 54 is disposed at one side of flange 18 and extends in a first axial direction (e.g., towards the plug distal end), while second seal portion 56 is disposed at the other opposing side of flange 18 and extends in a second axial direction opposite the first axial direction (e.g., away from the plug distal end).

The first seal portion 54 and second seal portion 54 may be provided as discrete seal elements each independently joined to plug 10 at flange 18, or may be provided as a single-piece construction commonly joined to plug 10 at flange 18. It should be understood that any conventional means may be used to secure seal 52 to plug 10.

The plug and seal assembly 50 operates similarly to the plug and seal assembly 4 of FIG. 2.

Referring now to FIG. 6, there is shown a plug and seal combination 60 similar to that shown in FIG. 2, but modified so that the functionality of inner O-ring seal 14 (FIG. 2) is now performed by an O-ring seal 62 annularly disposed about tube 8 and joined to the outer circumferential surface thereof by any means known to those skilled in the art. For this purpose, plug and seal combination 60 does not include an inner O-ring seal such as element 14 of FIG. 2.

Once tube 8 is fully installed in plug 10, seal 62 will provide the same sealing function as otherwise exhibited by inner O-ring seal 14 (FIG. 2). In particular, the installed position of tube 8 is shown in phantom in FIG. 6 to illustrate the similar placement and functionality of tube seal 62 relative to inner O-ring seal 14 (FIG. 2).

The plug and seal combination 60 operates similarly to the plug and seal assembly 4 of FIG. 2, once the combination of tube 8 and associated seal 62 are installed within plug 10.

Referring now to FIGS. 7-9, there are shown views of another form of the invention in which the functionality of the discrete outer annular face seal and inner O-ring tube seal (e.g., outer seal 12 and inner seal 14 in FIG. 2) has been merged, combined, and otherwise integrated into a single seal element. For this purpose, the integrated seal element finds particular usefulness in plug structures having a cylindrical-shaped body (as before), but without a radially extending flange, since a radial flange is not needed to join the integrated seal to the plug.

Referring to FIG. 7, there is shown a plug and seal assembly 70 that includes, in combination, a plug 11, seal 72, and membrane 16 (as before). Plug 11 is preferably the same in all respects to plug 10 discussed previously, but without a radial flange.

According to the invention, the illustrated seal 72 is provided in the form of a ring-type seal element annularly disposed about plug 11 and joined thereto using any conventional means known to those skilled in the art. In particular, as shown, seal 72 is suitably formed and joined to plug 11 at one terminal axial end thereof (e.g., the proximal end), so that seal 72 includes an axial portion 74 extending axially from plug 11; a first generally radial portion 76 extending generally radially outward from plug 11 (i.e., at outer plug surface 80), and a second generally radial portion 78 extending generally radially inward from plug 11 (i.e., at inner plug surface 82).

In view of this construction design for seal 72, it is seen (in reference to the installation environment depicted in phantom) that seal 72 (at first radial seal portion 76) provides a sealing surface with respect to component 6. Accordingly, first radial seal portion 76 constitutes the outer face seal functionality of plug and seal assembly 70. Thus, leakage from plug-to-housing clearance 84 is prevented.

Furthermore, seal 72 (at second radial seal portion 78) provides a sealing surface with respect to tube 8 (as indicated in phantom). Accordingly, second radial seal portion 78 constitutes the inner tube seal functionality of plug and seal assembly 7. Thus, leakage from plug-to-tube clearance 86 is prevented.

The benefit accruing from the seal design shown in FIG. 7 is that a single seal element can effectively and simultaneously provide the needed sealing action between the plug and tube and between the plug and external environment, e.g., transmission housing.

Referring to FIG. 8, there is shown a plug and seal combination 90 similar to that shown in FIG. 7, but modified to include an outer sleeve 92 annularly disposed about plug 11 and joined thereto at outer surface 80. Sleeve 92 is suitably formed and constructed to create an interference press fit with the opposing surface of component 6 (during installation), in order to facilitate firmer retention of plug and seal combination 90 in its installed position. For this purpose, for example, sleeve 92 will be formed of a material similar to the seals described herein, such as elastomer. In effect, sleeve 92 can provide additional sealing action between the exterior of plug 11 and the opposing transmission housing.

Sleeve 92 can be provided in various alternate forms. For example, sleeve 92 can extend between and connect seal 72 to membrane 16, thereby spanning the entire outer annular surface of plug 11 between these parts. As a result, sleeve 92 effectively closes out any possible clearance that might otherwise exist between the exterior of plug 11 and housing 6 in the absence of such sleeve 92.

Additionally, the combination of seal 72, sleeve 92, and membrane 16 can be provided as a single-piece, uni-body construction. Alternately, only seal 72 and sleeve 92 may be formed as a single piece, or just sleeve 92 and membrane 16. It should also be understood that sleeve 92 need not connect to either seal 72 or membrane 16, or it may connect to only one of these structures. Moreover, the axial extent of sleeve 92 may be less than the full amount between seal 72 and membrane 16. However, full coverage is advantageous because it increases the retention properties arising from the interference press fit.

The plug and seal assembly 90 operates similarly to the plug and seal assembly 70 of FIG. 7.

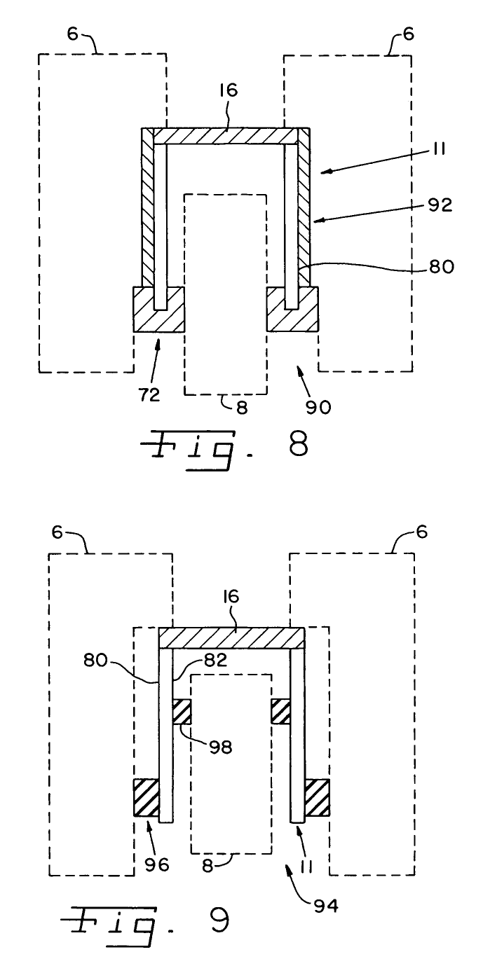

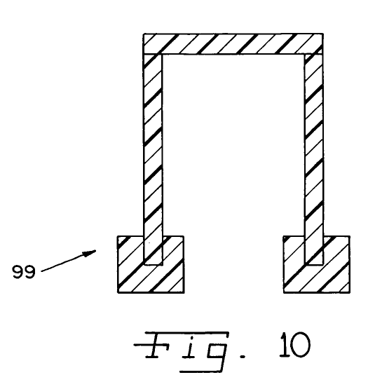

Referring to FIG. 9, there is shown a plug and seal combination 94 that includes, in combination, an outer seal 96 and an inner seal 98.

The outer seal 96 is provided in the form of a ring-type seal annularly disposed about plug 11 and joined thereto at outer annular surface 80 by any conventional means. Outer seal 96 serves as a face seal in terms of providing a sealing action between the exterior of plug 11 and the opposing surfaces of component 6, during installation.

The inner seal 98 is provided in the form of an annular O-ring seal disposed within plug 11 and joined thereto at inner annular surface 82 by any conventional means. Inner seal 98 serves as a tube seal in terms of providing a sealing action between the interior of plug 11 and the opposing surfaces of tube 8, during installation.

Referring to FIG. 10, there is shown a plug and seal combination 99 similar to plug and seal combination 70 of FIG. 7 to illustrate another form of the invention in which various ones of the parts are formed together as single unitized pieces. Accordingly, although combination 99 is shown as a specific adaptation of combination 70, this should not be considered in limitation of the invention.

Rather, assembly 99 is broadly representative of any plug and seal combination disclosed herein that may be constructed so that the plug and individual seals, or any combination thereof, are formed as a single-piece uni-body construction. For example, in one form, the plug and the associated seals are made from elastomer as a indivisible single piece.

More particularly, in one advantageous form, the entire plug and seal combination is formed as an integral unitized construction. For example, the entire assembly is formed as a single-piece uni-body construction. In a preferred form, the uni-body design is formed entirely of an elastomeric material. Any conventional technology can be used to manufacture, mold, and fabricate such a uni-body structure. Additionally, it should be apparent that the plug geometry will of course be tailored to accommodate its placement and serviceability in the ultimate application, namely, field installation.

This single body design, particularly when fabricated from elastomer, promotes ready installation and a tailor made custom fit to the transmission geometry since the elastomer body will be able to accommodate different installation profiles. This feature is available due to the ability of the elastomer body to conform in a deformable compressive manner to the transmission fitting. Additionally, this flexibility allows the plug and seal assembly to adjust to variations in dimensional tolerances due to flaws or deformations in the housing interface. As a result, such a single-body design could offer a universal-type plug and seal design.

The invention set forth herein has been described in conjunction with a transmission oil plug for use at an interface between a transmission housing block and housing block tube. However, this implementation should not be considered in limitation of the invention but merely illustrative of one exemplary arrangement, as it should be understood that the seal assembly described herein can find use in any other plug structures and other installation and/or application environments other than transmissions and/or housing block interfaces.

In particular, although the seal designs described herein are illustrated in conjunction with a plug associated with machine parts such as automatic transmission components, this depiction is for illustrative purposes only and should not be considered in limitation of the invention. Rather, the invention can be applied to and practiced in any environment where fluid coupling takes place. Accordingly, the seal arrangements discussed herein can be adapted for use in any plug, interface device, coupling apparatus, or other adapter means that facilitates the conveyance or communication of fluid, particularly across an interface boundary. The manner of performing such adaptation will be readily apparent to those skilled in the art.

Additionally, the invention is applicable to any environment and is not limited to vehicular applications, e.g., automatic transmission systems. Furthermore, although the seal designs herein are incorporated into a plug assembly, this deployment should not be considered in limitation of the invention, but merely illustrative of one exemplary use. Rather, the various seal designs herein may be installed within any device, mechanism, or structure that facilitates the communication or conveyance of fluid.

It should also be understood that the seals may offer leak protection against any kind of fluid depending upon the application, such as oil (e.g., transmission oil, engine oil, brake fluid, or clutch fluid), water, and coolant. For this purpose, the material composition of the seals will preferably be tailored to resist degradation and deterioration arising from exposure to the fluid environment. The manner of selecting the materials and fabrication processes for ensuring such seal integrity is readily within the knowledge of one skilled in the art.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A plug assembly at an interface between a first component and a second component, said plug assembly comprising:
a plug element comprising a plug body having a proximal end and a distal end, said plug element further comprising a generally radially extending flange at the proximal end of the plug body, the plug body defining an axial channel formed therethrough; and
a seal joined to the plug element flange, the seal extending at least axially inward toward the distal end of the plug body and axially outward away from the distal end of the plug body.

2. The plug assembly as recited in claim 1, wherein the seal being configured to extend annularly about a radially outermost surface of the plug element flange.

3. The plug assembly as recited in claim 1, further includes:
an annular seal disposed within the axial channel of the plug element.

4. The plug assembly as recited in claim 3, wherein the annular seal further includes:
an O-ring seal.

5. The plug assembly as recited in claim 3, further includes:
a membrane element joined to the plug element at the distal end thereof, the membrane element extending over an axial orifice of the plug element.

6. The plug assembly as recited in claim 1, further includes:
an inner annular seal disposed within the axial channel of the plug body;
a membrane element joined to the plug element at the distal end thereof, the membrane element extending over an axial orifice of the plug element; and
a seal member joined to the inner annular seal and the membrane element.

7. The plug assembly as recited in claim 1, wherein the seal being mechanically bonded to the plug element flange.

8. The plug assembly as recited in claim 7, further includes:
an inner annular seal disposed within the axial channel of the plug body; and
a membrane element joined to the plug element at the distal end thereof, the membrane element extending over an axial orifice of the plug element.

9. The plug assembly as recited in claim 7, wherein the seal being disposed at a radially intermediate point of the plug element flange.

10. The plug assembly as recited in claim 1, wherein the plug element and the seal being formed as a single-piece uni-body construction.

11. The plug assembly as recited in claim 10, wherein the single-piece uni-body construction being formed of an elastomeric material.

12. The plug assembly as recited in claim 1, wherein the first component and the second component constituting automatic transmission structures.

13. A plug assembly at an interface between a first component and a second component, said plug assembly comprising:
a plug element having a proximal end and a distal end and an axial channel defined therebetween, said plug element comprising a radially extending flange at the proximal end thereof; and
an outer seal annularly disposed about the plug element, the outer seal being joined to the plug element flange, the outer seal at least extending in axially opposite directions relative to the plug element flange.

14. The plug assembly as recited in claim 13, further includes:
an annular inner seal disposed within the axial channel of the plug element.

15. The plug assembly as recited in claim 14, further includes:
a membrane element joined to the plug element at the distal end thereof, the membrane element extending over an axial orifice of the plug element.

16. The plug assembly as recited in claim 15, further includes:
a means to connect the inner seal and the membrane element.

17. The plug assembly as recited in claim 16, wherein the inner seal, the membrane element, and the connection means constituting an integral uni-body construction.

18. The plug assembly as recited in claim 13, further includes:
a means to mechanically bond the outer seal to the plug element flange.

19. The plug assembly as recited in claim 18, further includes:
an inner annular seal disposed within the axial channel of the plug element; and
a membrane element joined to the plug element at the distal end thereof, the membrane element spanning an axial orifice of the plug element.

20. A plug assembly at an interface between a first component and a second component, said plug assembly comprising:
a plug element having a proximal end and a distal end and an axial channel defined therebetween, the plug element having a terminal axial edge at the proximal end thereof; and
a seal joined to the plug element at the terminal axial edge thereof, the seal at least extending radially inward and radially outward relative to the terminal axial edge.

21. The plug assembly as recited in claim 20, further includes:
a membrane element joined to the plug element at the distal end thereof, the membrane element spanning an axial orifice of the plug element.

22. The plug assembly as recited in claim 21, further includes:
a means to connect the seal and the membrane element, the connection means being annularly disposed about the plug element.

23. The plug assembly as recited in claim 22, wherein the seal, the membrane element, and the connection means constituting a single-piece uni-body construction.

24. The plug assembly as recited in claim 22, wherein the plug element, the seal, the membrane element, and the connection means constituting a single-piece uni-body construction.

25. The plug assembly as recited in claim 24, wherein the single-piece uni-body construction being formed of an elastomeric material.

26. An apparatus, comprising:
a plug element having a proximal end and a distal end, the plug element further having an inner annular surface defining an axial channel extending between the proximal end and the distal end of the plug element, said plug element comprising a radially extending flange at the proximal end thereof;
a first seal annularly disposed about the plug element, the seal being joined to the plug element flange, the seal at least extending in axially opposite directions relative to the plug element flange;
a tube received by the plug element through the axial channel thereof; and
a second seal annularly disposed about the tube, the second seal in press fit engagement with the plug element at the inner annular surface thereof.
